(19) United States
(12) Patent Application Publication
(10) Pub. No.: US 2014/0194074 A1
(43) Pub. Date: Jul. 10, 2014

(54) METHOD AND APPARATUS FOR WIRELESS COMMUNICATIONDEVICE MULTIBAND TUNABLE RADIO ARCHITECTURE

(71) Applicant: MOTOROLA MOBILITY LLC, Libertyville, IL (US)

(72) Inventors: Armin W. Klomsdorf, Chicago, IL (US); Gregory R. Black, Vernon Hills, IL (US); Richard E. Mach, Cary, IL (US); Dale G. Schwent, Schaumburg, IL (US)

(73) Assignee: MOTOROLA MOBILITY LLC, Libertyville, IL (US)

(21) Appl. No.: 13/735,560

(22) Filed: Jan. 7, 2013

(51) Int. Cl. H04B 1/00

(52) U.S. Cl. CPC H04B 1/005
USPC 455/77

(57) ABSTRACT

A method and apparatus provide a wireless communication device multiband tunable radio architecture. The apparatus can include a multiband transceiver configured to transmit and receive wireless communication signals. The apparatus can include a tunable transmit notch filter coupled to the multiband transceiver. The tunable transmit notch filter can provide low insertion loss in a transmit band and attenuation at a receive frequency. The apparatus can include a tunable circulator coupled to the tunable transmit notch filter. The tunable circulator can provide transmit to receive isolation. The apparatus can include a tunable receive filter coupled to the multiband transceiver. The tunable receive filter can provide low insertion loss at a receive frequency and attenuation at other frequencies.

### BACKGROUND

1. Field

The present disclosure is directed to a method and apparatus for wireless communication device multiband tunable radio architecture. More particularly, the present disclosure is directed to tunable filtering for a multiband wireless communication transceiver.

2. Introduction

Presently, a wireless communications multiband transceiver can transmit and receive wireless signals in multiple different frequency bands over a wireless communication network. The wireless communications multiband transceiver requires a dedicated duplex filter for each band. For a multiple antenna architecture, an additional antenna switch port or diplexing is also needed for each duplex filter. The wireless communications multiband transceiver must also provide isolation between transmit and receive frequencies to avoid transmit and receive signals from interfering in each other's signal paths.

Unfortunately, as the number of different frequency bands increase, the existing architecture becomes undesirable.

### BRIEF DESCRIPTION OF THE DRAWINGS

In order to describe the manner in which advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an example block diagram of a wireless communications network according to a possible embodiment;

FIG. 2 is an example block diagram of a wireless communication device according to a possible embodiment;

FIG. 3 is an example block diagram of an apparatus according to a possible embodiment;

FIG. 4 is an example block diagram of a tunable circulator according to a possible embodiment;

FIG. 5 is an example block diagram of an apparatus according to a possible embodiment;

FIG. 6 is an example block diagram of an apparatus according to a possible embodiment;

FIG. 7 is an example block diagram of an apparatus according to a possible embodiment;

FIG. 8 is an example block diagram of an apparatus according to a possible embodiment;

FIG. 9 is an example block diagram of an apparatus according to a possible embodiment; and

FIG. 10 is an example flowchart illustrating the operation of a wireless communication device according to a possible embodiment.

### DETAILED DESCRIPTION

A method and apparatus provide a wireless communication device multiband tunable radio architecture. The apparatus can include a multiband transceiver configured to transmit and receive wireless communication signals. The apparatus can include a tunable transmit notch filter coupled to the multiband transceiver. The tunable transmit notch filter can provide low insertion loss in a transmit band and attenuation at a receive frequency. The apparatus can include a tunable circulator coupled to the tunable transmit notch filter. The tunable circulator can provide transmit to receive isolation. The apparatus can include a tunable receive filter coupled to the multiband transceiver. The tunable receive filter can provide low insertion loss at a receive frequency and attenuation at other frequencies.

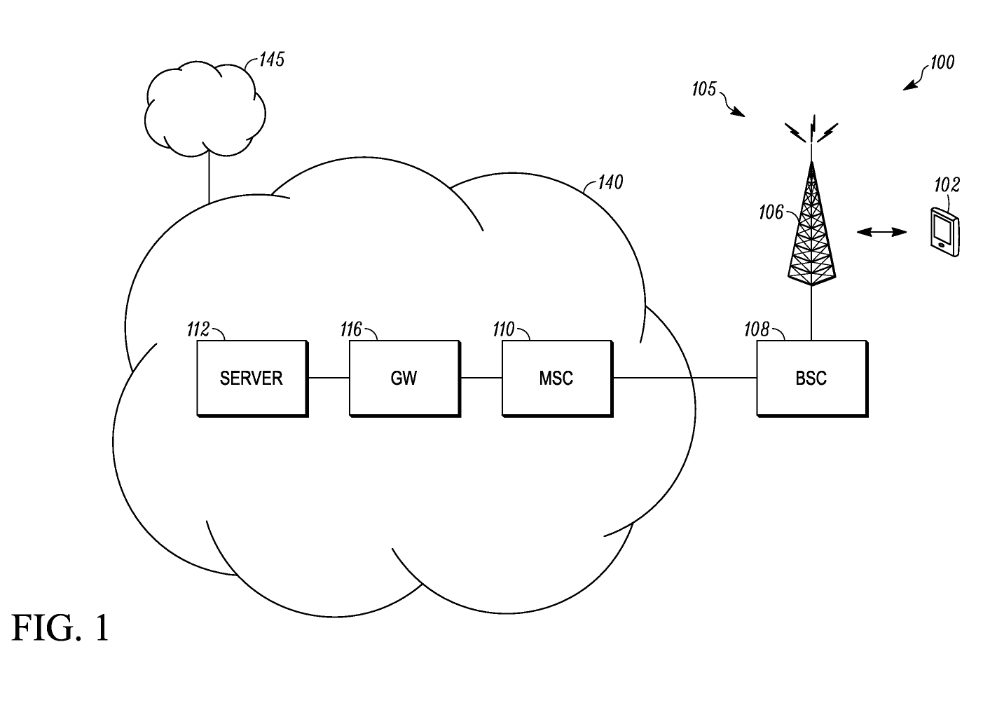

FIG. 1 is an example block diagram of a Wireless Communications Network (WCN) 100 according to a possible embodiment, within which certain functional aspects of the described embodiments may be implemented. WCN 100 can be any of the known or developed wireless communications networks including Code Division Multiple Access (CDMA), Time Division Multiple Access (TDMA), Global System of Mobile Communications (GSM), Orthogonal Frequency Division Multiplex (OFDM) networks, and further generations of such networks include 2.5, 3rd and 4th Generation Partnership Project (GPP) and Long Term Evolution (LTE) networks as well as hybrid or combined network that supports these and other wireless communication protocols. WCN 100 can be any of these wireless communications network in which at least one Wireless Communication Device (WCD) 102 operates with a channel between the WCD 102 serving as a client and a server 112 accessible through the WCN 100 and the Internet 145. WCN 100 utilizes standard signaling to enable communication of specific messages and data between network components, such as a Mobile Switching Center (MSC) 110 and a gateway 116, that are a part of WCN infrastructure 140.

The WCN 100 includes wireless communications device (WCD) 102, which can be a mobile device, mobile station, a cell phone, a smartphone, a laptop, a tablet, or any other wireless enabled device. In one embodiment, WCD 102 is a subscriber device to WCN 100 and wirelessly connects to the infrastructure of WCN 100 via base station (BS) 105, which can include a base station antenna 106 and a base station controller 108. Base station antenna 106 provides an access point to WCN 100 for WCD 102. In addition to the base station components 106 and 108, the infrastructure of WCN 100 can include the MSC 110, which is connected to BSC 108 as well as to a backbone of interconnected functional servers (not shown) of WCN 100. As shown, MSC 110 connects to and communicates with several other known network components (not shown) and with gateway 116. BSC 108, MSC 110, and other servers in a network 140 operate according to any of the mentioned protocols. The WCD 102 is able to connect to services provided by server 112 as well as connect to other WCD and other telecommunication equipment through the network 140 and other networks 145.

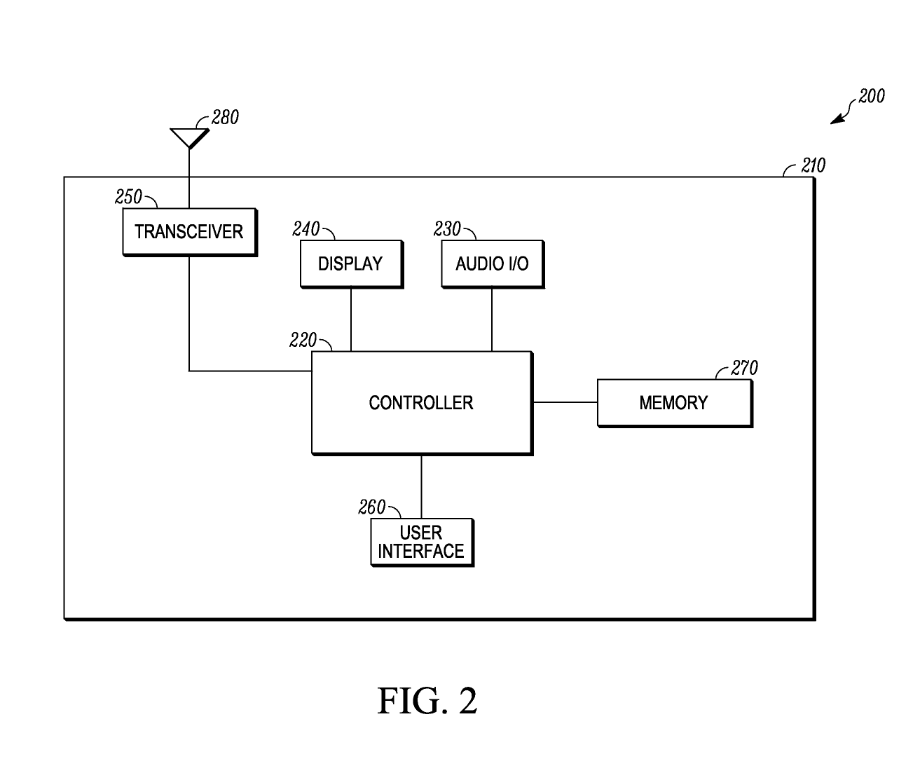

FIG. 2 is an example block diagram of a wireless communication device 200, such as the WCD 102, according to a possible embodiment. The wireless communication device 200 can include a housing 210, a controller 220 inside the housing 210, audio input and output circuitry 230 coupled to the controller 420, a display 240 coupled to the controller 420, a transceiver 250 coupled to the controller 420, a user interface 260 coupled to the controller 420, a memory 270 coupled to the controller 420, and an antenna 280 coupled to the transceiver 250.

The display 240 can be a liquid crystal display (LCD), a light emitting diode (LED) display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and an electronic device. The memory 270 may include a random access memory, a read only memory, an optical memory, a subscriber identity module memory, or any other memory that can be coupled to a wireless communication device.

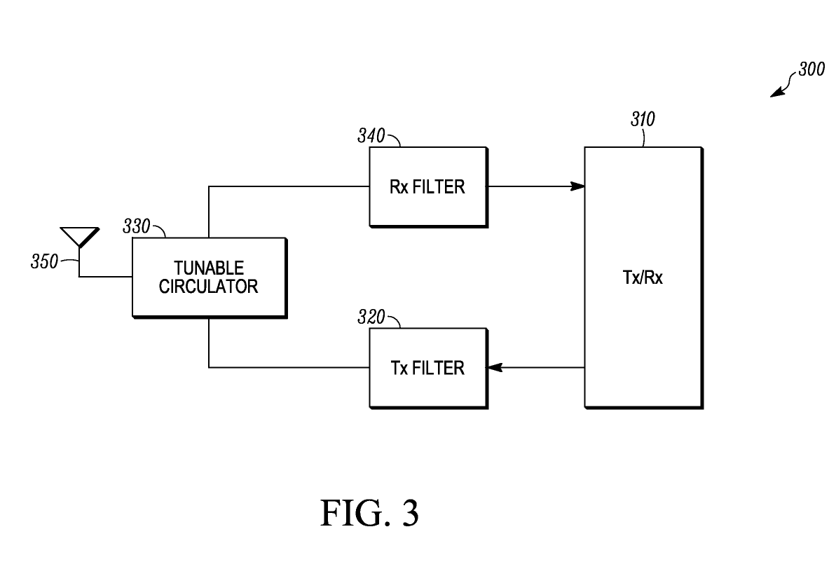

FIG. 3 is an example block diagram of an apparatus 300, such as the WCD 102, according to a possible embodiment. The apparatus 300 can be part of or can incorporate elements of the wireless communication device 200. The apparatus 300 can include a multiband transceiver 310 configured to transmit and receive wireless communication signals. The apparatus 300 can include a first tunable filter such as tunable transmit notch filter 320 coupled to the multiband transceiver 310. The tunable transmit notch filter 320 can provide low insertion loss in a transmit band and attenuation at a receive frequency. The apparatus 300 can include a tunable circulator 330 coupled to the tunable transmit notch filter 320. The tunable circulator can provide transmit to receive isolation. The apparatus 300 can include a second tunable filter such as tunable receive filter 340 coupled to the multiband transceiver 310. The tunable receive filter 340 can provide low insertion loss at a receive frequency and attenuation at other frequencies. The tunable circulator 330 can provide transmit signals from the multiband transceiver 310 via the tunable transmit notch filter 320 to an antenna 350 and can provide received signals from the antenna 350 to the multiband transceiver 310 via the tunable receive filter 340. The elements can be tunable in that the frequency of operation, amount of gain or filtering, impedance, or other parameters of the tunable elements can be adjustable.

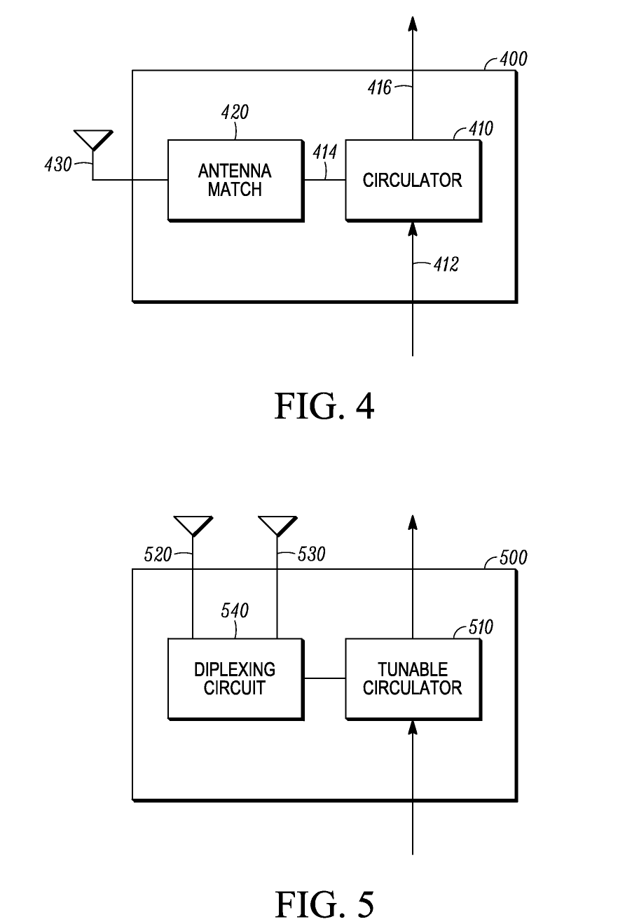

FIG. 4 is an example block diagram of a tunable circulator 400, such as the tunable circulator 330, according to a possible embodiment. The tunable circulator 400 can include a circulator 410 providing transmit-to-receive isolation. The tunable circulator 400 can include tunable antenna impedance match circuitry 420 coupled to the circulator 410 and coupled to an antenna 430. The tunable antenna impedance match circuitry 420 can provide transmit and receive band return loss to the circulator 410. The tunable circulator 400 can include a multiple port device with at least three ports and with properties of directivity, where a signal entering one port is coupled more strongly to a next port in rotation than to another port. For example, the tunable circulator 400 can include a first port 412 that receives a transmit signal. The tunable circulator 400 can include a second port 414 coupled to the antenna 430. The second port 414 can have a second port impedance and the antenna 430 can have an antenna impedance. The tunable circulator 400 can include a third port 416 that sends a receive signal. The second port 414 impedance can be tunably matched to the antenna 430 impedance to reduce signals flowing from the first port 412 to the third port 416 and to reduce signals flowing from the second port 414 to the first port 412. For example, the tunable antenna impedance match circuitry 420 can be coupled to the second port 414 and coupled to the antenna 430. The tunable antenna impedance match circuitry 420 can tunably match the second port impedance to the antenna impedance.

The tunable circulator 400 can operate at both the first carrier frequency and the second carrier frequency. The tunable circulator 400 can provide for carrier aggregation where one antenna can operate at both the first carrier frequency and the second carrier frequency. For example, for carrier aggregation, there can be multiple simultaneous transmissions and receptions. Two receive carriers at different carrier frequencies can be simultaneously received. The tunable circulator 400 can operate in two receive frequencies or bands at the same time. A tunable matching circuit 420 can provide an impedance match between the circulator 410 and the antenna 430 and can function at both of the receive carrier frequencies. Similarly two transmit signals can be simultaneously transmitted. The circulator 410 can operate in two transmit frequencies or bands at the same time. The tunable matching circuit 420 can provide an impedance match between the circulator 410 and the antenna 430 and can function at both of the transmit carrier frequencies.

The tunable circulator 400 can operate at both the first carrier frequency and the second carrier frequency. For example, for carrier aggregation there can be multiple simultaneous transmissions and receptions. As a further example, two receive carriers at different carrier frequencies can be simultaneously received. Thus, the tunable circulator 400 can operate in two receive frequencies or bands at the same time. In particular, the tunable matching circuit 420 can provide an impedance match between the circulator 410 and the antenna 430 and can function at both of the receive carrier frequencies. Similarly two transmit signals can be simultaneously transmitted. The circulator 410 can operate in two transmit frequencies or bands at the same time and the tunable matching circuit 420 can provide an impedance match between the circulator 410 and the antenna 430 and can function at both of the transmit carrier frequencies.

FIG. 5 is an example block diagram of an apparatus 500, such as a portion of the WCD 102 or a portion of the apparatus 300, according to a possible embodiment. The apparatus 500 can include a first antenna 520 coupled to a tunable circulator 510. The first antenna 520 can operate at a first carrier frequency. The apparatus 500 can include a second antenna 530 coupled to the tunable circulator 510. The second antenna can operate at a second carrier frequency. The apparatus 500 can include a diplexing circuit 540 coupled between the first antenna 520 and the tunable circulator 510 and coupled between the second antenna 530 and the tunable circulator 510. As discussed above, the tunable circulator 510 can operate at both a first carrier frequency and a second carrier frequency, which can provide for carrier aggregation. The second antenna 530 can be employed for carrier aggregation. The first antenna 520 and the second antenna 530 can be connected to the tunable circulator 510 with the diplexing circuit 540. The diplexing circuit 540 can provide the combined signal from the two antennas 520 and 530 to the tunable circulator 510.

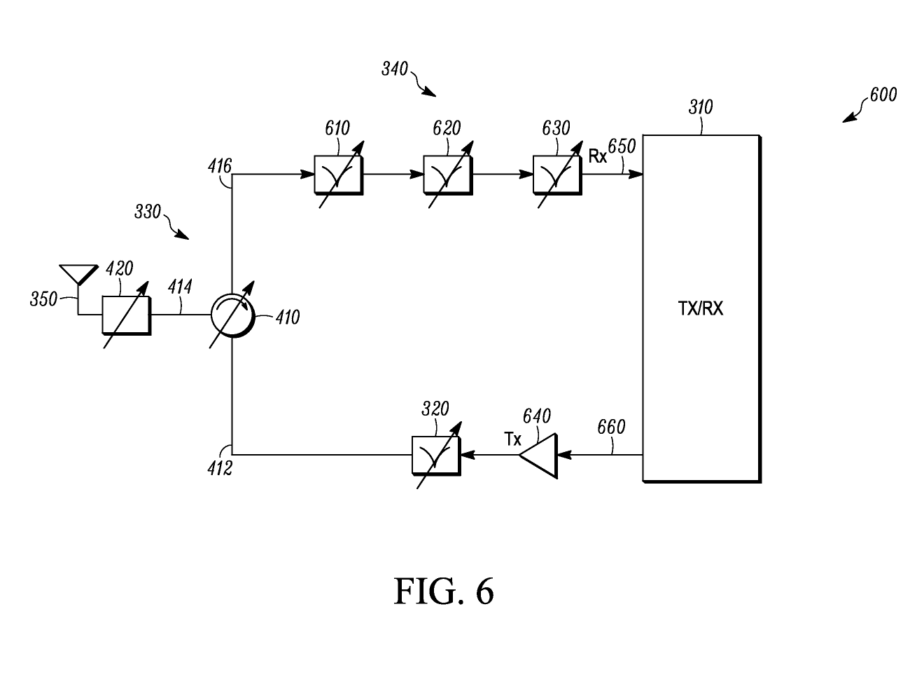

FIG. 6 is an example block diagram of an apparatus 600, such as the WCD 102 and the apparatus 300, according to a possible embodiment. The apparatus 600 can include the multiband transceiver 310, the tunable transmit notch filter 320, the tunable circulator 330, the tunable receive filter 340, and the antenna 350. The tunable circulator 330 can include the circulator 410 and the impedance match circuitry 420. The apparatus 300 can also include a power amplifier 640 that amplifies transmit signals from the multiband transceiver 310.

The tunable receive filter 340 provides a tunable frequency selective receive path for attenuating blocking signals which can cause a loss of receiver sensitivity in the multiband transceiver 310. Blocking signals can be transmit signals from the transceiver 310, interference signals from the antenna 350, or other signals caused by intermodulation of interference signals and transmit signals. The following blocking signal frequencies are possible problematic frequencies, listed in order from lowest to highest frequency, where RX denotes the receive frequency and TX denotes the transmit frequency:
a. “3^{rd} order mix up”: |TX−RX|/2
b. “2^{nd} order mix up”: |TX−RX|
c. “Receive divided by 3”: RX/3
d. “Receive divided by 2: RX/2
e. “Duplex Image”: 2TX−RX “Image”
f. “Half Duplex”: (TX+RX)/2
g. “2^{nd} order mix down”: (TX+RX)
h. “3^{rd} order mix down”: 2TX+RX

The “duplex image” and “half duplex” blocking signals can be especially problematic, since these occur closest to the receive frequency and may be difficult to attenuate with fixed or broadband filtering. In a preferred embodiment, the tunable receive filter 340 can include a first tunable receive notch filter 610 coupled to the multiband transceiver 310. The first tunable receive notch filter 610 can provide low insertion loss in a receive band and attenuation at a transmit frequency. The tunable receive filter 340 can include a second tunable receive notch filter 620 coupled to the multiband transceiver 310. The second tunable receive notch filter 620 can provide low insertion loss in a receive band and attenuation at a duplex image frequency, the duplex image frequency being two times a transmit frequency minus a receive frequency. The second tunable receive notch filter 620 can further provide low insertion loss in the receive band and can provide attenuation at a half-duplex frequency, where the half-duplex frequency can be the sum of the transmit and receive frequencies divided by two. The tunable receive filter 340 can include at least one third tunable receive notch filter 630 that can provide additional filtering, such as some of the filtering described above and other useful filtering.

For example, the multiband transceiver 310 can transmit signals in at least one transmit band and can receive signals in at least one different receive band. For example, the multiband transceiver 310 can transmit and/or receive at least 6, at least 7, at least from 8-10, or at least more than 10 bands. The tunable circulator 330 can provide transmit signals from the multiband transceiver 310 via the tunable transmit notch filter 320 to the antenna 350 via the tunable antenna impedance match circuitry 420 and can provide received signals from the antenna 350 via the tunable antenna impedance match circuitry 420 to the multiband transceiver 310 via the tunable receive notch filters 340. The tunable circulator 330 can be a passive non-reciprocal multiport device that transmits radio frequency signals entering any port to another port in rotation. The tunable circulator 330 can route signals transmitted from the multiband transceiver 310 to the antenna 350 via tunable antenna impedance match circuitry 420 and can route signals received from the antenna 350 via tunable antenna impedance match circuitry 420 to the multiband transceiver 310, while suppressing the passage of signals between transmit and receive circuitry. The notch filters 320, 610, 620, and 630 can be tuned to a frequency and can significantly attenuate, such as reject, frequencies in a frequency band, such as a range of frequencies.

The multiband transceiver 310 can include a multiband multimode radio frequency transceiver including a wideband transmit port 660 coupled to the tunable transmit notch filter 320 and a wideband receive port 650 coupled to the tunable receive filter 340. The power amplifier 640 can be a wideband power amplifier coupled between the multiband transceiver 310 and the tunable transmit notch filter 320. Tunable elements can be configured to operate in third generation partnership project bands from 1-41 and additional bands. The multiband transceiver 310 can provide tuning control for at least some of the tunable notch filters 320, 610, 620, and 630. The multiband transceiver 310 can also provide tuning control for other elements, including the tunable circulator 330 and the tunable antenna impedance match circuitry 420. For example, the multiband transceiver 310 can provide tuning control to adjust at least one tunable element based on operating conditions of the apparatus 600. The tuning and performance for each element can be adjusted for operating conditions. The operating conditions can include transmit signal level, receive signal level, interference signal frequency, blocker signal frequency, interference level, blocker level, and other operating conditions. Operating conditions can be monitored during operation of the receiver for determining the frequency and level of interfering or blocking signals. The frequency and level can be determined in the receiver itself and by special-purpose detectors.

The tunable antenna impedance match circuitry 420 can provide a return loss, such as within 10-25 dB, to the tunable circulator 410 at transmit and receive frequencies. According to another example, the tunable antenna impedance match circuitry 420 provides a return loss within 15-20 dB. Each combination of the tunable circulator 330 and each of one of at least one of the tunable receive notch filters 340 can provide at least 45 dB receive isolation for a tuned notch frequency of each receive notch filter. A combination of the tunable circulator 330 and one of at least one of the tunable receive notch filter provides 340 can also provide at least 45 dB receive isolation for a tuned notch frequency of the one of the tunable receive notch filters 340. According to another example, a combination of the tunable circulator 330 and one of the tunable receive notch filters 340 can provide at least 50 dB receive isolation. Furthermore, the tunable circulator 330 can provide isolation within 15-35% of the receive isolation and the tunable notch filters 340 can provides isolation within 65-85% of the receive isolation. For example, a transmit to receive isolation of 50+dB can be shared between the tunable notch filters 340 and the tunable circulator 330. Another possible partitioning can include 35-40 dB from the tunable notch filters 340 and 15-20 dB from the tunable circulator 330.

The tunable antenna impedance match circuitry 420 can provide impedance matching between the circulator 410 and the antenna 350. Impedance matching circuits can employ reactive components, such as inductors and capacitors, to transform the impedance of the antenna 350 to the impedance of the circulator 410, which can be 50 Ohms. The antenna 350 may be a narrow band antenna. Tunable impedance matching can be used to operate a narrow band antenna over a wide range of operating frequencies. Furthermore, the antenna impedance may be affected by a variety of factors, including the position of the apparatus 600 with respect to a user's body and a state of a communication system. When the impedance of the antenna 350 changes, the matching circuit 420 can be tuned in order to keep the impedances as closely matched as possible. The tunable impedance matching circuitry 420 can provide a complex conjugate match between an impedance of the circulator 410 and a complex impedance of the antenna 350, which can be different from 50 Ohms. In this way, power transfer between the circulator 410 and the antenna 350 can be maximized and reflected power can be minimized. Since reflected power is minimized, the return loss, which is the ratio of reflected power to incident power, can be maximized. When properly controlled to maximize return loss, a tuning network impedance at the antenna port can be set to the complex conjugate of the antenna impedance. In this condition, the impedance of the tuning network at the circulator port can be the complex conjugate of the circulator 410. Thus, the tunable matching circuit 420 can transform the circulator impedance to the complex antenna impedance, and can transform the complex antenna impedance to the circulator impedance. In this way, the tunable matching circuit 420 can minimize return loss of transmit signals coupling from the circulator 410 to the antenna 350, and can minimize return loss of receive signals coupling from the antenna 350 into the circulator 410, thereby matching the impedance of circulator 410 and the antenna 350.

The circulator 410 can be an n-port device (n>2) with properties of directivity, where a radio frequency signal entering any port can be coupled most strongly to the next port in rotation. For example, for a three port circulator, a signal applied to a first port 412 couples mostly to the second port 414, a signal applied to the second port 414 couples mostly to the third port 416, and a signal applied to the third port 416 couples mostly to the first port 412. The circulator 410 directivity can cause signals entering the transceiver 310 from the antenna 350 at the circulator second port 414 to couple most strongly to the third port 416, which is connected to the a receive port 650 of the transceiver 310. If the antenna impedance is not well matched, then a portion of the receive signal may get reflected back out of the second circulator port 414 and flow into the first circulator port 412, and thus, can be lost for use in the receiver which is connected at the third circulator port 416. Similarly, a signal exiting the transceiver port 660 from the transceiver 310 at the first circulator port 412 will couple most strongly to the second port 414, which is connected to the antenna 350. If the second circulator port 414 impedance is not well matched to the antenna 350, then a portion of the transmit signal can get reflected from the antenna 350 back into the second circulator port 414, which couples most strongly into the third circulator port 416. The reflection of signals can be averted by properly matching the antenna 350 to the second circulator port 414

The figure of merit of an antenna system is the system efficiency, which can be defined as the ratio of radiated power to power available from the source. The system efficiency can be denoted in dB units as η_{sys}:

η_{sys}=10*Log₁₀ [(radiated power)/(Power Available from the Source)]

The system efficiency can be broken down into two components: Radiation Efficiency and Delivered Power. In dB units, the radiation efficiency can be denoted as η_{rad}, and the delivered power can be denoted as G_{match}.

η_{sys}=η_{rad}+G_{match}

The radiation efficiency, η_{rad}, can be a property of the antenna, and the delivered power, G_{match}, can be a property of both the antenna and the matching circuit. G_{match} can be the ratio of power delivered to the antenna to the power available from the source. The figure of merit for antenna matching circuits can be the delivered power, G_{MATCH}:

G_{match}=10*Log₁₀ [(Power Delivered)/(Power Available from the Source)]

From equation 2, G_{MATCH} targets can be obtained by subtracting the radiation efficiency, η_{rad}, (in dB) from the requirements for system efficiency, η_{sys}. Thus, the matching circuit 350 can serve to match the impedance for the purpose of maximizing the delivered power, G_{match}.

However, physically small antennas of the types used in portable devices tend to have narrow bandwidth and cannot transmit and receive efficiently over a wide range of transmit and receive frequencies. Furthermore, the impedance of antenna 350 can be variable, depending on proximity to objects which can, for example, cause capacitive or dielectric loading such as metal surfaces, or a user's hand or body. Tunable matching can be employed to reduce mismatch caused by low antenna bandwidth and caused by changing antenna impedance. The circulator 410 combined with the tunable antenna impedance matching circuit 420 can be the tunable circulator 330 that provides the tunable matching.

The apparatus 600 can makes use of shared, wide bandwidth signal paths with common tunable band reject elements and duplexing through the tunable circulator 330. A transmit to receive isolation of about 50+dB can be shared between the notch filters 340 and the tunable circulator 330. For example, the notch filters 340 can provide 35-40 dB and the tunable circulator 330 can provide 15-20 dB. Some embodiments can simplify high band count multiband devices by eliminating fixed, band dedicated duplex filters and eliminating a high throw antenna switch. The isolation formerly met by duplex filters can be achieved with tunable notch filters 340, a tunable circulator 330, and tunable antenna match circuitry 420. The antenna match circuitry 420 can be tuned to achieve transmit to receive isolation across the circulator 330.

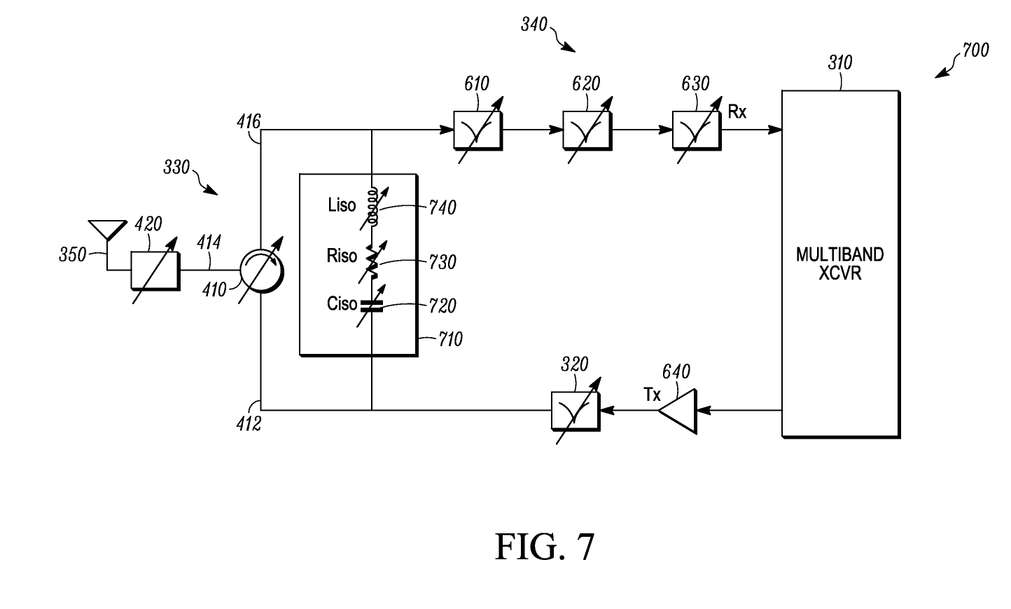

FIG. 7 is an example block diagram of an apparatus 700, such as the WCD 102 and the apparatus 300, according to a possible embodiment. The apparatus 700 can include the elements discussed above. For example, the tunable circulator 330 can include the first port 412 that receives a transmit signal from the tunable transmit notch filter 320. The tunable circulator 330 can include the second port 414 that receives a receive signal from the antenna 350. The tunable circulator 330 can include the third port 416 that sends the receive signal to the tunable receive filter 340. The apparatus 700 can also include a feed forward cancelation circuit 710 coupled between the tunable circulator first port 412 and the tunable circulator third port 416. The feed forward cancelation circuit 710 can cancel transmitted signals from received signals. For example, additional transmit signal cancellation can be achieved at the transceiver 310 input by applying the feed forward cancellation circuit 710 to cancel the transmit signal coupling into a receiver of the transceiver 310. The feed forward cancellation circuit 710 can be an open loop canceller applied between the circulator transmit port 412 and the circulator receive port 416. According to one example, the feed forward cancellation circuit 710 can include a tunable capacitor 720, a tunable resistor 730, and a tunable inductor 740. The tunable canceller 710 can couple a “cancelling signal” from the transmit port of the circulator 412 to the receive port of the circulator 416. Capacitor 720, resistor 730 and inductor 740 can be selected to provide the amplitude and phase of the cancelling signal at the transmit frequency. The capacitor 720, resistor 730, and inductor 740 can serve to couple the transmit signal to the receive port 416 thereby affecting the amplitude of the cancelling circuit. Capacitor 720 and inductor 740 can serve to adjust the phase of the cancelling signal. Capacitor 720 can provide coupling with a negative phase and inductor 740 can provide coupling with a positive phase. By selecting the circuit values of capacitor 720, resistor 730, and inductor 740, a cancelling signal can be provided, having the same amplitude and the opposite phase of the “coupled signal” coupling out of the circulator at receive port 416 at the transmit frequency. The summation of the cancelling signal and the coupled signal can cause attenuation of the signal coupling into the receive filter 340 at the transmit frequency.

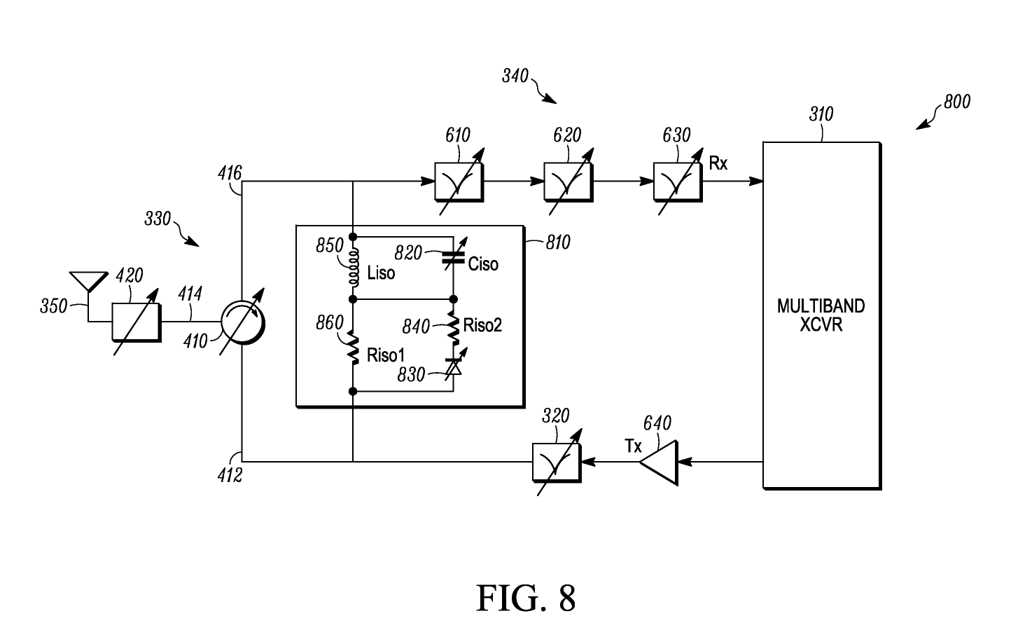

FIG. 8 is an example block diagram of an apparatus 800, such as the apparatus 700, according to a possible embodiment. The apparatus 800 can include the elements discussed above. The apparatus 800 can also include a feed forward cancelation circuit 810 coupled between the tunable circulator first port 412 and the tunable circulator third port 416. The feed forward cancelation circuit 810 can cancel transmitted signals from received signals. The feed forward cancellation circuit 810 can include a tunable capacitor 820, tunable PIN diode 830 based resistor 840, a fixed inductor 850, and an additional resistor 860. In this implementation, the capacitance and resistance of the feed forward cancelation circuit 810 can be programmed to generate a transmit signal level which has the same amplitude and the opposite phase of the transmit signal from the circulator 410.

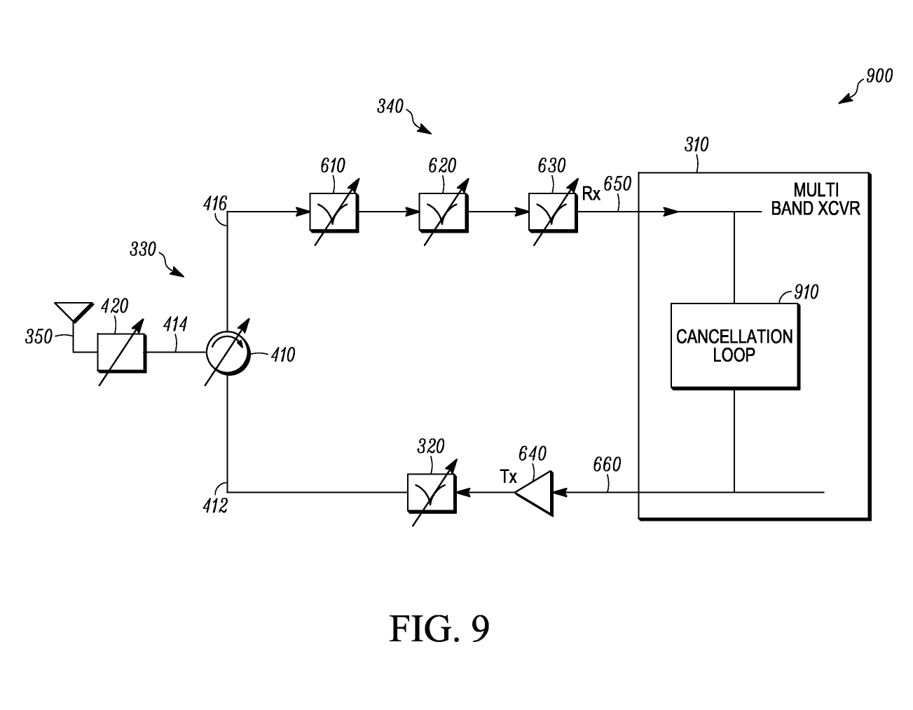

FIG. 9 is an example block diagram of an apparatus 900, such as the WCD 102 and the apparatus 300, according to a possible embodiment. The apparatus 900 can include the elements discussed above. For example, the multiband transceiver 310 can include the transmit port 660 coupled to the tunable transmit notch filter 320 and the receive port 650 coupled to the tunable receive filter 340. The apparatus 900 can also include a cancelation loop 910 coupled to the multiband transceiver transmit port 660 and the multiband transceiver receive port 650. The cancelation loop 910 can automatically determine an amplitude and phase of a canceling signal that cancels transmitted signals from received signals. The cancelation loop 910 can also be employed at other places in the receive path, such as after the tunable filters 320 and 340 where the transmit signal may be more variable. The cancellation loop 910 can employ a down-converter that down-converts baseband using a transmit signal as a local oscillator, a baseband loop filter and gain blocks, and an up-converter that converts a cancelation signal back to an appropriate Radio Frequency (RF) frequency.

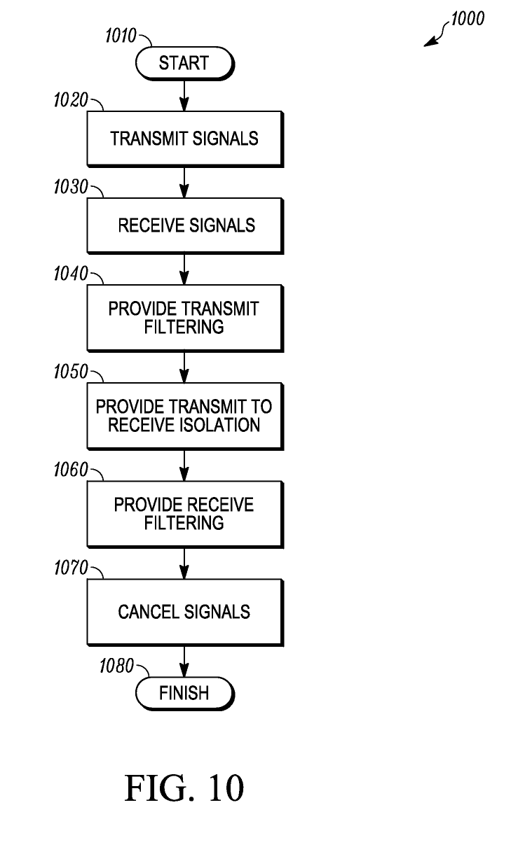

FIG. 10 is an example flowchart 1000 illustrating the operation of the wireless communication device 200 according to a possible embodiment. At 1010, the flowchart begins. At 1020, the wireless communication device 200 can transmit wireless communication signals from a multiband transceiver. At 1030, the wireless communication device 200 can receive wireless communication signals for the multiband transceiver. At 1040, the wireless communication device 200 can provide low insertion loss in a transmit band and attenuation at a receive frequency using a tunable transmit notch filter coupled to the multiband transceiver. At 1050, the wireless communication device 200 can provide transmit to receive isolation using a tunable circulator coupled to the tunable transmit notch filter. At 1060, the wireless communication device 200 can provide low insertion loss at a receive frequency and attenuation at other frequencies using a tunable receive filter coupled to the multiband transceiver. The tunable circulator can provide transmit signals from the multiband transceiver via the tunable transmit notch filter to an antenna and provides received signals from the antenna to the multiband transceiver via the tunable receive filter. At 1070, the wireless communication device 200 can cancel transmitted signals from received signals using a cancelation circuit coupled between a multiband transceiver transmit port and a multiband transceiver receive port. At 1080, the flowchart 1000 can end.

The method of this disclosure is preferably implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. An apparatus comprising:
a multiband transceiver configured to transmit and receive wireless communication signals;
a tunable transmit notch filter coupled to the multiband transceiver, the tunable transmit notch filter providing low insertion loss in a transmit band and attenuation at a receive frequency;
a tunable circulator coupled to the tunable transmit notch filter, the tunable circulator providing transmit to receive isolation; and
a tunable receive filter coupled to the multiband transceiver, the tunable receive filter providing low insertion loss at a receive frequency and attenuation at other frequencies.

2. The apparatus according to claim 1, wherein the tunable circulator provides transmit signals from the multiband transceiver via the tunable transmit notch filter to an antenna and provides received signals from the antenna to the multiband transceiver via the tunable receive filter.

3. The apparatus according to claim 1, wherein the tunable circulator comprises:
a circulator providing transmit to receive isolation; and
tunable antenna impedance match circuitry coupled to the circulator and coupled to an antenna, the tunable antenna impedance match circuitry providing transmit and receive band return loss to the circulator.

4. The apparatus according to claim 1, wherein the tunable receive filter comprises:
a first tunable receive notch filter coupled to the multiband transceiver, the first tunable receive notch filter providing low insertion loss in a receive band and attenuation at a transmit frequency; and
a second tunable receive notch filter coupled to the multiband transceiver, the second tunable receive notch filter providing low insertion loss in a receive band and attenuation at an image frequency.

5. The apparatus according to claim 4, wherein the second tunable receive notch filter provides low insertion loss in the receive band and provides attenuation at a duplex image frequency.

6. The apparatus according to claim 4, wherein the second tunable receive notch filter provides low insertion loss in the receive band and provides attenuation at a half-duplex image frequency.

7. The apparatus according to claim 1, wherein the multiband transceiver comprises a multiband multimode radio frequency transceiver including a wideband transmit port coupled to the tunable transmit notch filter and a wideband receive port coupled to the tunable receive filter.

8. The apparatus according to claim 1, wherein the tunable circulator comprises a multiple port device with at least three ports and with properties of directivity, where a signal entering one port is coupled more strongly to a next port in rotation than to another port.

9. The apparatus according to claim 1,
wherein the tunable circulator comprises:
a first port that receives a transmit signal;
a second port coupled to an antenna, the second port having a second port impedance and the antenna having an antenna impedance; and
a third port that sends a receive signal, and
wherein the second port impedance is tunably matched to the antenna impedance to reduce signals flowing from the first port to the third port and to reduce signals flowing from the second port to the first port.

10. The apparatus according to claim 9, wherein the tunable circulator comprises tunable antenna impedance match circuitry coupled to the second port and coupled to the antenna, where the tunable antenna impedance match circuitry tunably matches the second port impedance to the antenna impedance.

11. The apparatus according to claim 1, further comprising:
a first antenna coupled to the tunable circulator, the first antenna configured to operate at a first carrier frequency;
a second antenna coupled to the tunable circulator, the second antenna configured to operate at a second carrier frequency; and
a diplexing circuit coupled between the first antenna and the tunable circulator and coupled between the second antenna and the tunable circulator,
wherein the tunable circulator is configured to operate at both the first carrier frequency and the second carrier frequency.

12. The apparatus according to claim 1,
wherein the tunable circulator comprises:
a first port that receives a transmit signal from the tunable transmit notch filter;
a second port that receives a receive signal from an antenna; and
a third port that sends the receive signal to the tunable receive filter, and
wherein the apparatus comprises a feed forward cancelation circuit coupled between the tunable circulator first port and the tunable circulator third port, where the feed forward cancelation circuit cancels transmitted signals from received signals.

13. The apparatus according to claim 1,
wherein the multiband transceiver includes a transmit port coupled to the tunable transmit notch filter and a receive port coupled to the tunable receive filter,
wherein the apparatus comprises a cancelation loop coupled to the multiband transceiver transmit port and the multiband transceiver receive port, where the cancelation loop automatically determines an amplitude and phase of a canceling signal that cancels transmitted signals from received signals.

14. A method comprising:
transmitting wireless communication signals from a multiband transceiver;
receiving wireless communication signals for the multiband transceiver;
providing low insertion loss in a transmit band and attenuation at a receive frequency using a tunable transmit notch filter coupled to the multiband transceiver;
providing transmit to receive isolation using a tunable circulator coupled to the tunable transmit notch filter; and
providing low insertion loss at a receive frequency and attenuation at other frequencies using a tunable receive filter coupled to the multiband transceiver.

15. The method according to claim 14, wherein the tunable circulator provides transmit signals from the multiband transceiver via the tunable transmit notch filter to an antenna and provides received signals from the antenna to the multiband transceiver via the tunable receive filter.

16. The method according to claim 14, wherein the tunable circulator comprises:
a circulator providing transmit to receive isolation; and
tunable antenna impedance match circuitry coupled to the circulator and coupled to an antenna, the tunable antenna impedance match circuitry providing transmit and receive band return loss to the circulator.

17. The method according to claim 14, wherein the tunable receive filter comprises:
a first tunable receive notch filter coupled to the multiband transceiver, the first tunable receive notch filter providing low insertion loss in a receive band and attenuation at a transmit frequency; and
a second tunable receive notch filter coupled to the multiband transceiver, the second tunable receive notch filter providing low insertion loss in a receive band and attenuation at an image frequency.

18. The method according to claim 14, further comprising canceling transmitted signals from received signals using a cancelation circuit coupled between a multiband transceiver transmit port and a multiband transceiver receive port.

19. The method according to claim 14, wherein the tunable receive filter comprises:
a first tunable receive notch filter coupled to the multiband transceiver, the first tunable receive notch filter providing low insertion loss in a receive band and attenuation at a transmit frequency; and
a second tunable receive notch filter coupled to the multiband transceiver, the second tunable receive notch filter providing low insertion loss in a receive band and attenuation at an image frequency.

20. A wireless communication device comprising:
a multiband transceiver configured to transmit and receive wireless communication signals;
a tunable transmit notch filter coupled to the multiband transceiver, the tunable transmit notch filter providing low insertion loss in a transmit band and attenuation at a receive frequency;
a tunable circulator coupled to the tunable transmit notch filter, the tunable circulator providing transmit to receive isolation, the tunable circulator providing transmit signals from the multiband transceiver to an antenna via the tunable transmit notch filter; and
a tunable receive filter coupled to the multiband transceiver, the tunable receive filter providing low insertion loss at a receive frequency and attenuation at other frequencies,
wherein the tunable circulator provides receive signals from the antenna to the multiband transceiver via the tunable receive filter.
